(19) United States
(12) Patent Application Publication
(10) Pub. No.: US 2007/0202911 A1
(43) Pub. Date: Aug. 30, 2007

(54) System And Method For Energy Efficient Signal Detection In A Wireless Network Device

(75) Inventors: Olaf Hirsch, Sunnyvale, CA (US); Charles Razzell, Pleasanton, CA (US); Yifeng Zhang, San Jose, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIKE PHILIPS ELECTRONICS N.V., EINDHOVEN NETHERLAND (NL)

(21) Appl. No.: 10/569,205

(22) PCT Filed: Aug. 28, 2004
(86) PCT No.: PCT/US04/28144

§ 371 Date: Oct. 13, 2006

Related U.S. Application Data
(60) Provisional application No. 60/498,456, filed on Aug. 28, 2003.

(51) Int. Cl. H04B 7/00

(52) U.S. Cl. 455/522; 455/69; 455/41.2

(57) ABSTRACT

An incoming signal, such as a data frame, is detected in a RF stage (302) of a wireless station (300). This allows the baseband stage (304) to be in a low power or off state until an incoming signal is detected. By detecting an incoming signal in the RF stage (302), the amount of power consumed by the baseband stage (304) is advantageously reduced. When an incoming signal is detected, the RF stage (302) generates an activation signal that is sent to the baseband stage (304) to activate the baseband stage (304). Once activated, the baseband stage (304) receives the signal and performs signal processing and data recovery operations.

The invention relates to wireless network systems, and more particularly to signal detection in wireless network devices. Still more particularly, the invention relates to a system and method for energy efficient signal detection in a wireless network device.

Recent and ongoing innovations in wireless technology have resulted in the increased use of wireless systems in a number of applications, including wireless network systems. This increased use has lead to a need for efficient devices that assist in the transmission of data in the wireless network. One such device is a signal detector, which detects an incoming signal on an antenna connected to a wireless station.

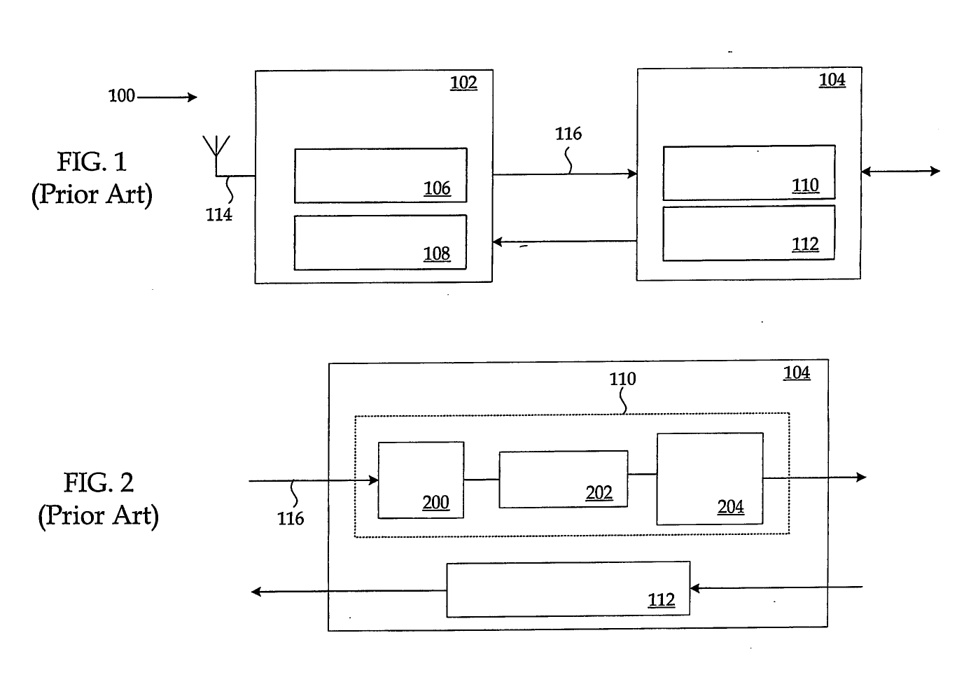

FIG. 1 illustrates a wireless station according to the prior art. Wireless station 100 includes a RF stage 102 and a baseband stage 104. RF stage 102 includes a receiver section 106 and a transmitter section 108. Baseband stage 104 also includes a receiver section 110 and a transmitter section 112. Baseband stage 104 is typically connected to a device such as a computer, a personal digital assistant (PDA), a printer, or a data storage medium (not shown).

FIG. 2 is a block diagram of the baseband stage 104. One of the functions of the receiver 110 in baseband stage 104 is the detection of an incoming signal on antenna 114. An analog-to-digital converter (ADC) 200 receives an analog baseband signal from the RF stage 102 on line 116 and converts the signal to a digital signal. This digital signal is input into detector 202, which detects whether a data frame has been received by wireless station 100. If a data frame has been received, the signal is input into baseband operations 204 for signal processing and data recovery.

Because the times at which incoming signals will be received are unknown, both receivers 106, 110 in wireless station 100 must be on at all times. Power must therefore be supplied continuously to the RF stage 102 and to the baseband stage 104. Batteries customarily supply the power to wireless station 100. The need for a continuous supply of power, however, reduces the amount of time the batteries will be functional.

In accordance with the invention, a system and method for energy efficient signal detection in a wireless network is provided. An incoming signal, such as a data frame, is detected in the RF stage of a wireless station. This allows the baseband stage to be in a low power or off state until an incoming signal is detected. By detecting an incoming signal in the RF stage, the amount of power consumed by the baseband stage is advantageously reduced. When an incoming signal is detected, the RF stage generates an activation signal that is sent to the baseband stage to activate the baseband stage. Once activated, the baseband stage receives the signal and performs signal processing and data recovery operations.

FIG. 1 is a block diagram of a wireless station according to the prior art;

FIG. 2 is a block diagram of the baseband stage shown in FIG. 1;

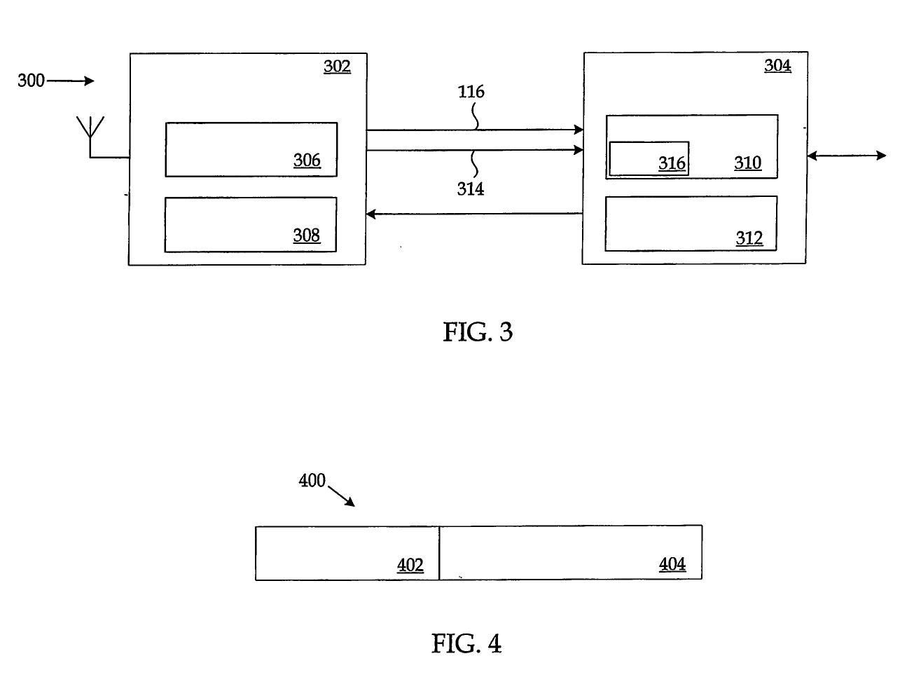

FIG. 3 is a block diagram of a wireless station in accordance with the invention;

FIG. 4 is an illustration of a data frame that may be utilized in accordance with the invention;

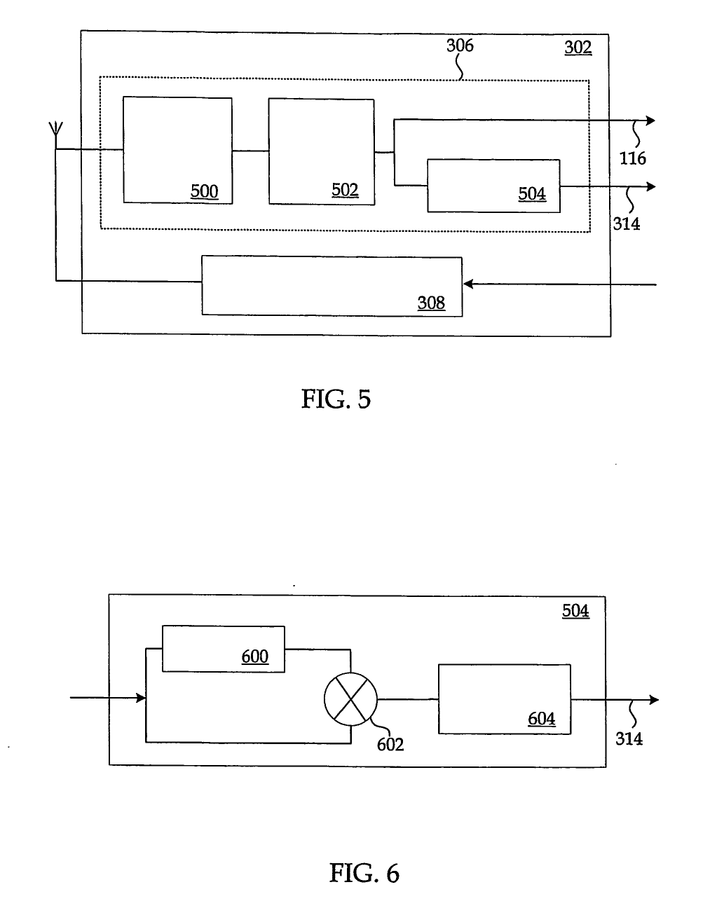

FIG. 5 is a block diagram of one embodiment of a RF stage shown in FIG. 4;

FIG. 6 is a block diagram of the detector shown in FIG. 5 in a first embodiment in accordance with the invention;

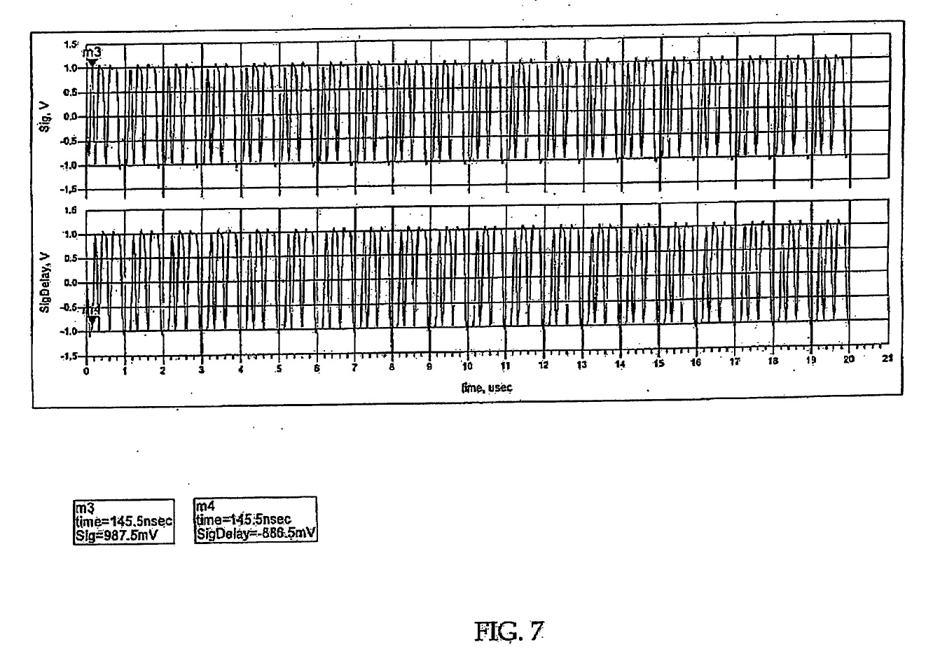

FIG. 7 illustrates an incoming signal waveform and a delayed incoming signal waveform that are input into the correlator shown in FIG. 6;

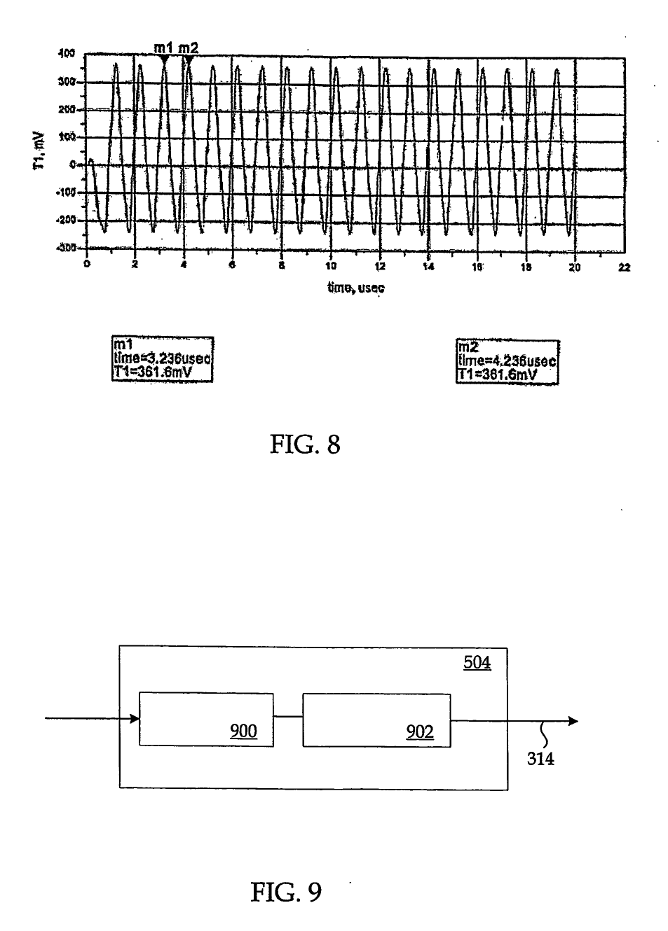

FIG. 8 depicts a waveform of a signal output from the correlator shown in FIG. 6; and

FIG. 9 is a block diagram of the detector shown in FIG. 5 in a second embodiment in accordance with the invention.

The invention relates to system and method for energy efficient signal detection in a wireless network device. The following description is presented to enable one skilled in the art to make and use the invention, and is provided in the context of a patent application and its requirements. Various modifications to the disclosed embodiments in accordance with the invention will be readily apparent to those skilled in the art, and the generic principles herein may be applied to other embodiments in accordance with the invention. Thus, the invention is not intended to be limited to the embodiments shown, but is to be accorded the widest scope consistent with the appended claims and with the principles and features described herein.

With reference now to the figures and in particular with reference to FIG. 3, there is shown a block diagram of a wireless station in accordance with the invention. Wireless station 300 includes a RF stage 302 and a baseband stage 304. RF stage 302 includes a receiver section 306 and a transmitter section 308. RF stage 302 is typically implemented as an analog stage in one or more integrated circuits. Baseband stage 304 includes a receiver section 310 and a transmitter section 312. Baseband stage 304 is typically implemented as a digital stage in one or more integrated circuits.

Detection of an incoming signal is performed in the receiver 306 in RF stage 302 in this embodiment in accordance with the invention. This allows the receiver 310 in baseband stage 304 to be in a low power or off state until a signal is detected. By detecting an incoming signal in the RF stage 302, the amount of power consumed by the baseband stage 304 is advantageously reduced.

When an incoming signal is detected, an activation signal is generated by the RF stage 302 and transmitted on line 314 to the receiver 310 in baseband stage 304. The activation signal causes the receiver 310 in the baseband stage 304 to transition from a low power state to an active power state. This may be accomplished using a variety of techniques. For example, in one embodiment in accordance with the invention, the activation signal may be input into a clock 316 in receiver 310, which in turn activates the components in receiver 310. In another embodiment in accordance with the invention, the activation signal may be input into a power supply to switch on or ramp up the power supplied to receiver 310. Once the receiver 310 is activated, the baseband stage 304 receives the signal and performs signal processing and data recovery operations. Those skilled in the art will recognize that other methods for activating receiver 310 in baseband stage 304 may be implemented in accordance with the invention.

In wireless networks, an incoming signal is typically formatted as a data frame. FIG. 4 is an illustration of a data frame that may be utilized in accordance with the invention. Data frame 400 includes a preamble 402 and a payload 404. Preamble 402 usually includes data related to frame detection. Payload 404 typically includes the data and information relating to the recovery of the data.

In this embodiment in accordance with the invention, wireless station 300 operates pursuant to the IEEE 802.11 or 802.11b standard governing wireless local area networks. The 802.11 and 802.11b standards utilize a Barker sequence (+1, −1, +1, +1, −1, +1, +1, +1, −1, −1, −1) in the preamble 402 for frame detection. Thus, the receiver 306 in RF stage 302 analyzes an incoming signal to detect a Barker sequence and determine the presence of a data frame.

Sequences other than a Barker sequence may be detected in accordance with the invention. For example, the IEEE 802.11a and 802.11g standards utilize a sequence of OFDM (Orthogonal Frequency Division Multiplexing) symbols for frame detection. A RF stage may detect a sequence of OFDM symbols to determine the presence of a signal or data frame in other embodiments in accordance with the invention.

FIG. 5 is a block diagram of one embodiment of a RF stage shown in FIG. 4. The receiver 306 includes a low noise amplifier 500, a down conversion operation 502, and a detector 504. An incoming signal is transmitted in the 2.4 GHz band under the IEEE 802.11 standard. This 2.4 GHz signal must be down modulated before being transmitted to the baseband stage. Down conversion operation 502 performs this down modulation. Detector 504 detects the Barker sequence in each incoming data frame and generates the activation signal that is sent to the baseband stage to activate the receiver 310 in baseband stage 304.

Referring now to FIG. 6, there is shown a block diagram of the detector shown in FIG. 5 in a first embodiment in accordance with the invention. Detector 504 includes a delay 600, a correlator 602, and a peak detector 604. An incoming signal is input into delay 600 in order to insert a predetermined time delay in the signal. Both the incoming signal and the delayed incoming signal are then input into a correlator 602. The correlator 602 is a multiplier in this embodiment in accordance with the invention. Thus, correlator 602 multiplies the incoming signal with the delayed incoming signal to produce a signal having peaks that are more easily detected.

A peak detector and peak counter 604 detect the Barker sequence in the signal output from the correlator 602. The peak detector and peak counter 604 generate the activation signal that is transmitted to the receiver 310 in baseband stage 304. The activation signal activates the receiver 310 to cause the receiver 310 to transition from a low power state to a high (i.e., active) power state. When the receiver 310 is in the high power state, the baseband stage 304 receives and processes the incoming data frame. The receiver 310 is returned to the low power or off state after the frame is processed. The receiver 310 remains in a low power or off state until the receiver 306 in RF stage 302 detects a new incoming frame.

FIG. 7 illustrates an incoming signal waveform and a delayed incoming signal waveform that are input into the correlator shown in FIG. 6. A signal having more discernible peaks is produced when incoming signal 700 and delayed incoming signal 702 are multiplied. FIG. 8 depicts a waveform of a signal output from the correlator 602.

Referring now to FIG. 9, there is shown a block diagram of the detector shown in FIG. 5 in a second embodiment in accordance with the invention. Detector 504 includes a matched filter 900 and a peak detector 902. The matched filter 900 may be implemented as a continuous time finite response filter in this embodiment in accordance with the invention. In other embodiments in accordance with the invention, the matched filter 900 may be implemented as a discrete time finite response filter.

The coefficients of the matched filter are defined by the Barker pseudo-noise code +1, −1, +1, −1, +1, +1, +1, −1, −1, −1. The tap delay is defined by the data rate of 1 Mbps to 1 μs. The Barker sequence is detected at the output of the matched filter 900 by peak detector 902. Once the sequence is detected, the peak detector 902 generates the activation signal that is transmitted to the receiver 310 in baseband stage 304. The activation signal activates the receiver 310, thereby allowing the baseband stage 304 to process the incoming data frame. The receiver 310 is returned to a low power or off state after the frame is processed, and remains in a low power or off state until the receiver 306 in RF stage 302 detects a new incoming frame.

Although the invention has been described in the context of detecting a Barker sequence as defined in IEEE 802.11 and 802.11b, embodiments in accordance with the invention are not limited to this application. Other types of sequences can also be detected in a RF stage of a wireless station in accordance with the invention. The length and complexity of a sequence are just two of the factors to consider when determining whether a sequence should be detected in the RF stage or in the baseband stage in a wireless station.

1. A RF stage in a wireless station comprising: a detector for detecting a sequence in an incoming signal received by the wireless station and for generating an activation signal in response to detecting the sequence in the incoming signal.

2. The RF stage as claimed in claim 1, characterized in that a baseband stage in the wireless station receives the activation signal and transitions from a low power state to an active power state in response to receiving the activation signal.

3. The RF stage as claimed in claim 1, characterized in that the detector comprises: a delay for inserting a predetermined time delay into the incoming signal; a correlator for receiving the incoming signal and the delayed incoming signal and for generating a correlated signal; and a peak detector for receiving the correlated signal and for detecting the sequence, wherein the peak detector generates the activation signal in response to detecting the sequence.

4. The RF stage as claimed in claim 1, characterized in that the detector comprises: a matched filter having coefficients defined by the sequence and for generating a match signal when the sequence is included in the incoming signal; and a peak detector for receiving the match signal from the matched filter and for generating the activation signal in response to receiving the match signal from the matched filter.

5. The RF stage as claimed in claim 5, characterized in that the incoming signal comprises a data frame including the sequence and the sequence comprises a Barker sequence.

6. The RF stage as claimed in claim 5, characterized in that the incoming signal comprises a data frame including the sequence and the sequence comprises a sequence of OFDM symbols.

7. A wireless station, comprising: a baseband stage in a low power state when a signal is not received by the wireless station and a RF stage for detecting a sequence in a signal received by the wireless station and for generating an activation signal in response to detecting the sequence, wherein the activation signal is transmitted to the baseband stage to cause the baseband stage to transition from the low power state to an active power state.

8. The wireless station as claimed in claim 7, characterized in that the RF stage comprises a receiver for detecting the sequence in the signal received by the wireless station and for generating the activation signal in response to detecting the sequence.

9. The wireless station as claimed in claim 8, characterized in that the receiver comprises a detector for detecting the sequence in the signal and for generating the activation signal in response to detecting the sequence.

10. The wireless station as claimed in claim 9, characterized in that the detector comprises: a delay for inserting a predetermined time delay into the signal; a correlator for receiving the signal and the delayed signal and for generating a correlated signal; and a peak detector for receiving the correlated signal and for detecting the sequence, wherein the peak detector generates the activation signal in response to detecting the sequence.

11. The wireless station as claimed in claim 9, characterized in that the detector comprises: a matched filter having coefficients defined by the sequence for receiving the signal and for generating a match signal when the sequence is included in the signal; and a peak detector for receiving the match signal from the matched filter and for generating the activation signal in response to receiving the match signal from the matched filter.

12. The wireless station as claimed in claim 7, characterized in that the signal comprises a data frame including the sequence and the sequence comprises a Barker sequence.

13. The wireless station as claimed in claim 7, characterized in that the signal comprises a data frame including the sequence and the sequence comprises a sequence of OFDM symbols.

14. A method for detecting a sequence in a signal received by a wireless station, comprising the steps of: detecting the sequence in a RF stage in the wireless station and generating an activation signal in response to detecting the sequence.

15. The method as claimed in claim 14, further comprising the step of transmitting the activation signal to a baseband stage in the wireless station to cause the baseband stage to transition from a low power state to an active power state.

16. The method as claimed in claim 14, characterized in that the step of detecting the sequence in a RF stage in the wireless station comprises the step of detecting the sequence in a detector in the RF stage in the wireless station.

17. The method as claimed in claim 16, characterized in that the step of detecting the sequence in a detector in the RF stage in the wireless station comprises the steps of: inputting the signal into a delay for inserting a predetermined time delay into the signal; inputting the signal and the delayed signal into a correlator for generating a correlated signal; and inputting the correlated signal into a peak detector for detecting the sequence.

18. The method as claimed in claim 16, characterized in that the step of detecting the sequence in a detector in the RF stage in the wireless station comprises the steps of: inputting the signal into a matched filter having coefficients defined by the sequence; generating a match signal when the sequence is included in the signal; and inputting the match signal into a peak detector to cause the peak detector to generate the activation signal in response to receiving the match signal from the matched filter.

19. The method as claimed in claim 14, characterized in that the signal comprises a data frame including the sequence and the sequence comprises a Barker sequence.

20. The method as claimed in claim 14, characterized in that the signal comprises a data frame including the sequence and the sequence comprises a sequence of OFDM symbols.
